(19) United States
(12) Patent Application Publication
(10) Pub. No.: US 2026/0192808 A1
(43) Pub. Date: Jul. 9, 2026

(54) ONLINE OBJECT-LEVEL BIAS ESTIMATION FOR MULTI-SENSOR FUSION

(71) Applicant: Torc Robotics, Inc., Blacksburg, VA (US)

(72) Inventor: Haseeb Chaudhry, Blacksburg, VA (US)

(21) Appl. No.: 19/009,687

(22) Filed: Jan. 3, 2025

(51) Int. Cl. B60W 50/00

(52) U.S. Cl. CPC B60W 50/0098; B60W 2050/0083; B60W 2420/403; B60W 2420/408; B60W 2420/54; B60W 2556/10; B60W 2556/35

(57) ABSTRACT

In one aspect, a computer-implemented method, includes receiving, from a first sensor, a first set of object data associated with a location of an object in a three-dimensional space. The first sensor may be associated with a first bias. The method may further include receiving, from a second sensor, a second set of object data associated with the location of the object in the three-dimensional space. The second sensor may be associated with a second bias. The method may further include predicting, using a trained machine-learning model, a combined bias. The trained machine-learning model may be trained using historical sets of object data and historical biases to estimate a position of one or more objects in the three-dimensional space. The method may further include generating a calibrated location of the object based on the combined bias using the trained machine-learning model.

### TECHNICAL FIELD

The field of the disclosure relates generally to state estimation and, more specifically, estimating relative bias in state estimation across different sources of data in real time.

### BACKGROUND OF THE INVENTION

This invention relates to autonomous vehicle systems which require little or no human interaction to operate the vehicle and navigate it from an origin location to a destination location. This invention may also find use with simpler, semi-autonomous systems, such as ADAS (advanced driver assistance systems), as will be understood by those of skill in this art.

For proper operation, autonomous vehicles can collect large amounts of data regarding the surrounding environment. Such data may include data regarding other vehicles driving on the road, identifications of traffic regulations that apply (e.g., speed limits from speed limit signs or traffic lights), or other objects that impact how autonomous vehicles may drive safely. Automated vehicles must be capable of operating in a variety of environmental conditions to complete driving tasks safely. In order to adapt to current conditions, the automated vehicle must gather, analyze, and generate accurate information regarding the conditions. Some measurements, such as temperature, are trivial to capture and already exist on many conventional and automated vehicles. Other measurements pertaining to current environmental conditions, such current locations of objects in an environment, present more difficulties.

To gather these measurements associated with the autonomous vehicle, automated vehicles may use one or more sensors. The one or more sensors may experience bias. Bias in sensors on autonomous vehicles refers to systematic errors or inconsistencies in the data collected by sensing systems, which can lead to incorrect or incomplete environmental interpretations about the surrounding environment. Such biases can arise from various factors, including environmental conditions (e.g., lighting, weather), sensor design limitations, and algorithmic processing discrepancies. For example, LIDAR sensors may underperform in rain or fog, while cameras might struggle with glare or low-light scenarios, creating a disparity in data reliability across different contexts. Identifying and mitigating these biases is crucial for ensuring robust and equitable performance of autonomous systems in diverse real-world environments.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a computer-implemented method, includes receiving, from a first sensor, a first set of object data associated with a location of an object in a three-dimensional space. The first sensor may be associated with a first bias. The method may further include receiving, from a second sensor, a second set of object data associated with the location of the object in the three-dimensional space. The second sensor may be associated with a second bias. The method may further include predicting, using a trained machine-learning model, a combined bias. The trained machine-learning model may be trained using historical sets of object data and historical biases to estimate a position of one or more objects in the three-dimensional space. The method may further include generating a calibrated location of the object based on the combined bias using the trained machine-learning model.

In another aspect, the method may include adjusting the first bias and the second bias based on the combined bias. In another aspect, the method may include periodically updating the calibrated location according to a predefined time interval. In another aspect, the method may include querying a computing device for feedback regarding the accuracy of the calibrated location of the object relative to an actual location of the object, and updating the trained machine-learning model based on the feedback. In another aspect, the method may include processing the first set of object data and the second set of object data in a preprocessing layer of the trained machine-learning model, where the preprocessing layer transforms input data to generate normalized object data. In another aspect, at least one of the first set of object data and the second set of object data may include cuboid information, which includes at least a center point, a size, and an orientation angle of a cuboid.

In another aspect, the first sensor may be a first type and the second sensor may be a second type, where the first type may be distinct from the second type. In another aspect, the first sensor may be a first type and the second sensor may be a second type, where the first type may be the same as the second type. In another aspect, the first sensor may be a first type and the second sensor may be a second type, where the first type and the second type may be each at least one of a camera, a Light Detection and Ranging (LiDAR) sensor, a Radio Detection and Ranging (RADAR) sensor, or ultrasound sensor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck according to some aspects of the present disclosure.

FIG. 2 is a block diagram of the autonomous truck shown in FIG. 1 according to some aspects of the present disclosure.

FIG. 3A illustrates a bird's-eye view of a roadway including a schematic representation of a vehicle and aspects of an autonomy system of the vehicle according to some aspects of the present disclosure.

FIG. 3B illustrates a perspective view of a detected vehicle within a detection area of the vehicle according to some aspects of the present disclosure.

FIG. 4 illustrates an example neural architecture of a neural network defined by an example neural network description in a neural controller according to some aspects of the present disclosure.

FIG. 5 illustrates a state estimation module according to some aspects of the present disclosure.

FIG. 6 illustrates a method for state estimation according to some aspects of the present disclosure.

FIG. 7 is a block diagram of an example computing system according to some aspects of the present disclosure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Autonomous vehicles equipped with autonomous driving perception systems typically use multiple sensors with corresponding object detectors to provide measurements of discrete objects in a given three-dimensional environment. The measurements are generally collected by a “tracking” component associated with the autonomous vehicle, which combines the measurements together to generate an overall estimation of an object in the three-dimensional space. This estimation may include a position, speed, acceleration, classification, any combination thereof, or the like. The estimation may enable the autonomous vehicle to adjust and operate appropriately relative to the object.

The corresponding object detectors (e.g., sensors equipped on the autonomous vehicle) may exhibit bias in detected measurements (e.g., error) based on a number of factors, including, but not limited to, weather, hardware limitations, cleanliness, distance to object, type of object, age of sensor (e.g., older equipment may exhibit increased bias), noise, signal interference, any combination thereof, or the like. The bias may be mitigated by comparing a measurement from an object detector to a known truth sample. However, the bias associated with an object detector may not be consistent across all measurements associated with the object detector. For example, the type of object, the time of day, the distance of the object, the cleanliness of the object detector at a given point in time, the weather, any combination thereof, or the like, may impact the present error of the object detector. While an absolute error (e.g., comparing a measurement to a known truth sample) may be determined, the resulting error distributions are not representative of the true bias between individual measurements of the same object in real time, and are rather an overall generalization across all possible error states.

By utilizing machine-learning, a tracking system may be capable of dynamically tracking the bias associated with a measurement of an object in real-time. Using the dynamic bias, the tracking system may also generate a more accurate and precise location associated with the object. In some examples, the tracking system may receive a first measurement and a second measurement associated with a first object detector and a second object detector, respectively. In most instances, the first measurement and the second measurement may not be identical, indicating a level of bias in the first object detector and/or the second object detector. The tracking system may, using the first measurement and the second measurement, predict an actual calibrated location of the object using respective biases associated with the first object detector and/or the second object detector. As more data is received (e.g., data regarding the object from the first object detector and the second object detector), biases associated with the first object detector and/or the second object detector may be updated to maintain and/or improve accuracy.

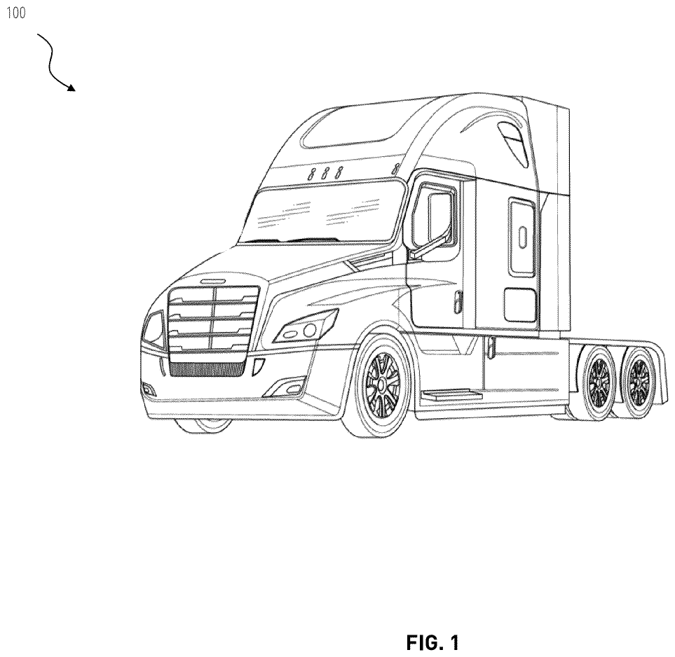

FIG. 1 illustrates a vehicle 100, such as a truck that may be conventionally connected to a single or tandem trailer to transport the trailer (not shown) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of the cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

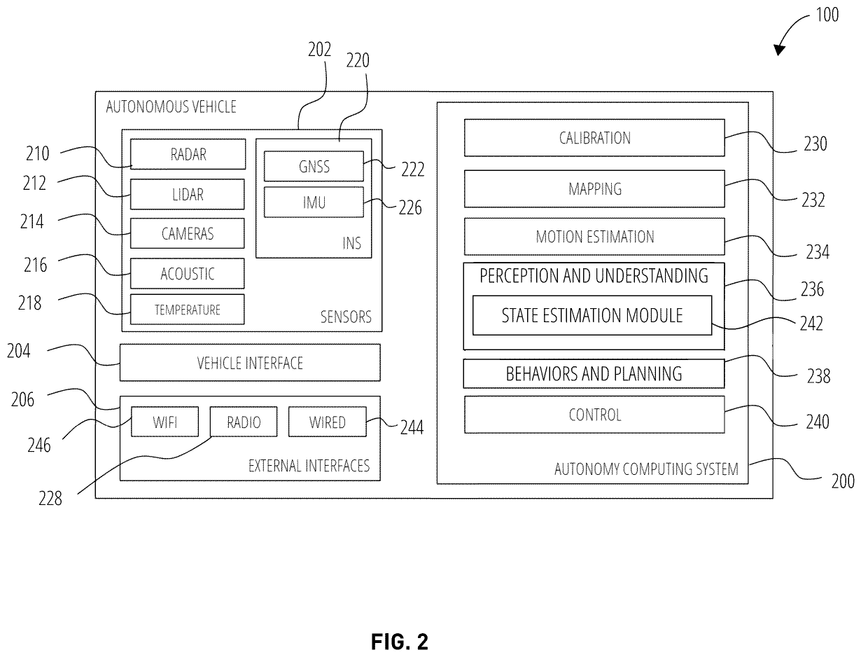

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 226. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 226 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 226 may measure an acceleration, angular rate, or an orientation of autonomous vehicle 100 or one or more of its individual components using a combination of accelerometers, gyroscopes, or magnetometers. IMU 226 may detect linear acceleration using one or more accelerometers and rotational rate using one or more gyroscopes and attitude information from one or more magnetometers. In some embodiments, IMU 226 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 246 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a state estimation module 242. The state estimation module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The state estimation module 242 may perform one or more tasks including, but not limited to generating calibrated locations associated with one or more objects in a three-dimensional space, updating biases for one or more sensors (e.g., sensors of sensors 202, such as RADAR sensors 210, LiDAR sensors 212, cameras 214, etc.), training and configuring a machine-learning model, analyzing sensor data from one or more sensors (e.g., sensors of sensors 202), transmitting calibrated locations of the one or more objects to other modules within autonomous vehicle 100 (e.g., behaviors and planning module 238, mapping module 232, calibration module 230, motion estimation module 234, and/or any other module associated with autonomous vehicle 100), transmitting biases associated with one or more sensors to a remote server associated with autonomous vehicle 100, any combination thereof, or the like.

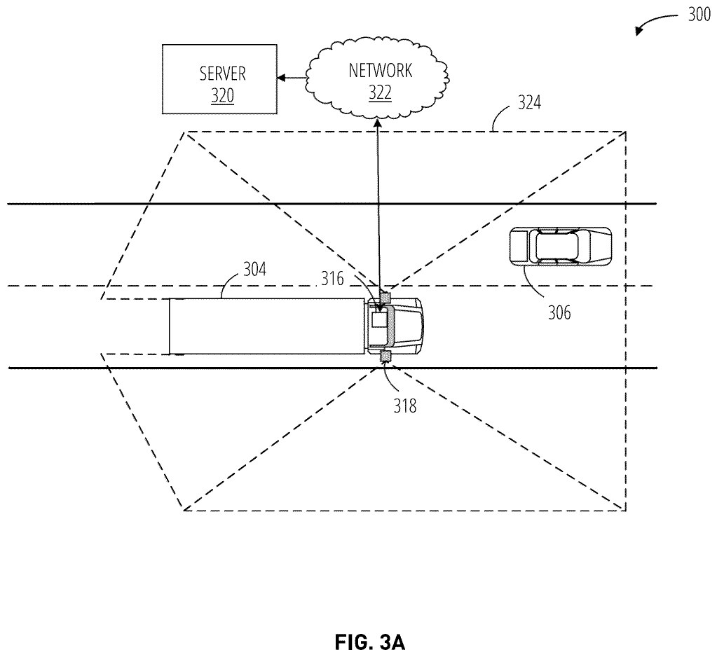

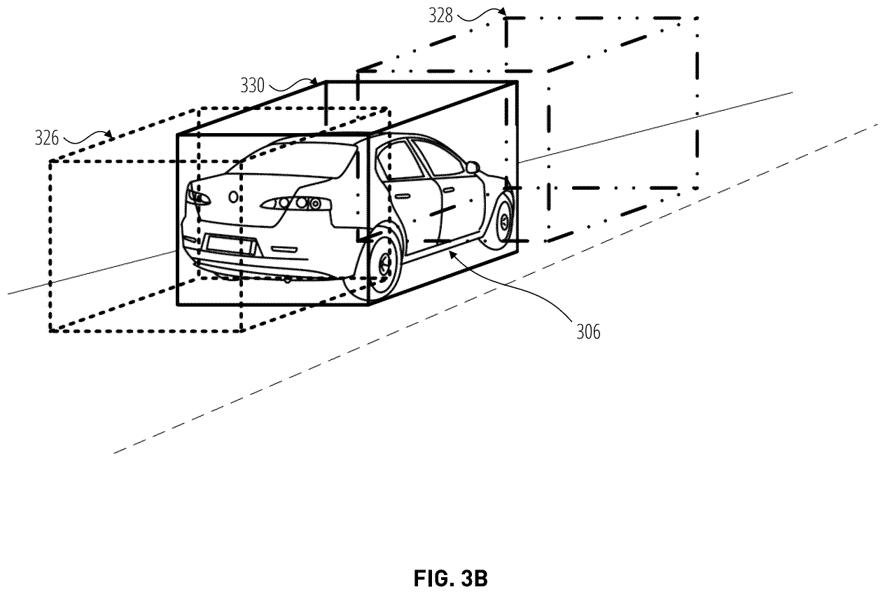

FIG. 3A illustrates a bird's-eye view of a roadway including a schematic representation of a vehicle and aspects of an autonomy system of the vehicle according to some aspects of the present disclosure. Referring to FIG. 3A, the present disclosure relates to autonomous vehicles, such as an autonomous vehicle 304 having an autonomy system 316. Autonomous vehicle 304 may be similar to and perform similar functions as vehicle 100 shown in FIGS. 1-2. Referring again to FIG. 3A, an autonomy system 316 of the vehicle 304 may be completely autonomous (fully autonomous), such as self-driving, driverless, or Level 4 autonomy, or semi-autonomous, such as Level 3 autonomy. As used herein the term “autonomous” includes both fully autonomous and semi-autonomous. The present disclosure sometimes refers to autonomous vehicles as ego vehicles. The autonomy system 316 may be structured on at least three aspects of technology: (1) perception, (2) maps/localization, and (3) behaviors planning and control. The function of the perception aspect is to sense an environment surrounding the vehicle 304 and interpret the environment. To interpret the surrounding environment, a perception module 318 or engine in the autonomy system 316 of the vehicle 304 may identify and classify objects or groups of objects in the environment. For example, a perception module 318 may be associated with various sensors (e.g., light detection and ranging (LiDAR), camera, radar, etc.) of the autonomy system 316 and may identify one or more objects (e.g., pedestrians, vehicles, debris, etc.) and features of the roadway (e.g., lane lines) around the vehicle 304, and classify the objects in the road distinctly.

The maps/localization aspect of the autonomy system 316 may be configured to determine where on a pre-established digital map the vehicle 304 is currently located. In certain embodiments, autonomy system 316 senses the environment surrounding the vehicle 304 (e.g., via the perception module 318), such as by detecting vehicles (e.g., a vehicle 306) or other objects (e.g., traffic lights, speed limit signs, pedestrians, signs, road markers, etc.) from data collected via the sensors of the autonomy system 316, and to correlate features of the sensed environment with details (e.g., digital representations of the features of the sensed environment) on the digital map.

Once the systems on the vehicle 304 have determined the location of the vehicle 304 with respect to the digital map features (e.g., location on the roadway, upcoming intersections, road signs, etc.), the vehicle 304 can plan and execute maneuvers and/or routes with respect to the features of the digital map. The behaviors, planning, and control aspects of the autonomy system 316 may be configured to make decisions about how the vehicle 304 should move through the environment to get to the goal or destination of the vehicle 304. The autonomy system 316 may consume information from the perception and maps/localization modules to know where the vehicle 304 is relative to the surrounding environment and what other objects and traffic actors are doing.

FIG. 3A further illustrates an environment for modifying one or more actions of the vehicle 304 using the autonomy system 316. The vehicle 304 is capable of communicatively coupling to a remote server 320 via a network 322. The vehicle 304 may not necessarily connect with the network 322 or the server 320 while it is in operation (e.g., driving down the roadway). That is, the server 320 may be remote from the vehicle, and the vehicle 304 may deploy with all the necessary perception, localization, and vehicle control software and data necessary to complete the vehicle 304's mission fully autonomously or semi-autonomously.

While this disclosure refers to a vehicle 304 as the autonomous vehicle, it is understood that the vehicle 304 could be any type of vehicle including a truck (e.g., a tractor trailer), an automobile, a mobile industrial machine, etc. While the disclosure will discuss a self-driving or driverless autonomous system, it is understood that the autonomous system could alternatively be semi-autonomous having varying degrees of autonomy or autonomous functionality. While the perception module 318 is depicted as being located at the front of the vehicle 304, the perception module 318 may be a part of a perception system with various sensors placed at different locations throughout the vehicle 304.

FIG. 3B illustrates a perspective view of a detected vehicle within a detection area of the vehicle according to some aspects of the present disclosure. As illustrated above in FIG. 3A, vehicle 304 may detect vehicle 306. A state estimation module may process the detection of vehicle 306 and determine the most accurate location of vehicle 306. It should be noted that the state estimation module is not limited to vehicles. In some examples, state estimation module may process the detection of a pedestrian, a tree, a sign, a bicycle, a building, a fountain, a bridge, or any other object that may occur in a three-dimensional space while vehicle 304 is operating autonomously. Vehicle 304 may be equipped with one or more sensors configured to detect objects within a detection area 324 of vehicle 306 and may transmit object data associated with vehicle 306 to the state estimation module.

Detector A may detect vehicle 306 and may generate a cuboid indicating the location of vehicle 306 in the three-dimensional space, cuboid 326. Cuboid 326 may include one or more data points, including, but not limited to, a center point, a size (e.g., height, width, length, etc.), and an orientation. Detector B, which is distinct from Detector A, may detect vehicle 306 and may also generate a second cuboid, cuboid 328, indicating the location of vehicle 306. The state estimation module may record cuboid 326 and cuboid 328. In some examples, the state estimation module may also record the difference between cuboid 326 and cuboid 328. Detector A and Detector B may also be associated with a respective bias. The bias may be determined by prior object data, a post-processing server that determines the accuracy of a given sensor, derived by offline calculations done with respect to a ground truth, or, in some examples, may be set to zero.

Detector A and Detector B may continue to transmit object data (e.g., a respective cuboid indicating the location of vehicle 306) to the state estimation module. As Detector A and Detector B continue to provide object data, the state estimation module may update the respective bias of Detector A and Detector B. In some examples, this may be performed by a neural network configured to generate bias predictions for sensors (e.g., Detector A and Detector B). For example, a first neural network may be trained on historical object data and historical bias predictions to update a current bias associated with Detector A. In some examples, the first neural network may perform similar updating on a current bias associated with Detector B. In some examples, the first neural network may force one of the biases to zero. For example, the first neural network may determine that Detector A is historically more accurate than Detector B, therefore may minimize the impact of Detector B by increasing the bias associated with Detector B. This may include reducing the bias associated with Detector A accordingly, such as reducing it to zero.

Using the bias associated with Detector A and Detector B, state estimation module may generate a combined bias indicative of the most likely location of vehicle 306. The state estimation module may make this prediction based on the bias associated with Detector A, the bias associated with Detector B, historical data associated with Detector A and/or Detector B, historical data associated with a vehicle similar to vehicle 306, any combination thereof, or the like. In some examples, the state estimation module may normalize the object data received from Detector A and/or Detector B. For example, if Detector A and Detector B are different types of sensors (e.g., Detector A is a camera and Detector B is a LiDAR sensor), the object data associated with each detector may be formatted differently. Thus, state estimation module may perform preprocessing (e.g., using a layer of the first neural network, using a second neural network, etc.) to normalize the object data. This may include modifying, transforming, updating, shifting, calibrating, adjusting, any combination thereof, or the like, the object data. The state estimation module may use the normalized object data to generate the combined bias. The combined bias, in some examples, may be a cuboid, such as cuboid 330. In some examples, the state estimation module may output updated biases (e.g., respective biases associated with Detector A and Detector B), and a second module may generate a cuboid that reflects the updated biases to generate the most likely location of vehicle 306 (e.g., cuboid 330).

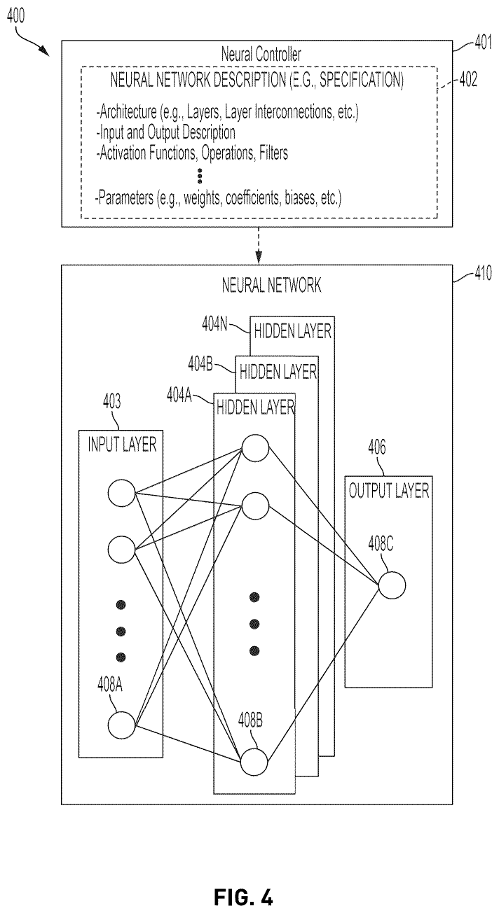

FIG. 4 illustrates an example neural architecture 400 of a neural network 410 defined by an example neural network description 402 in neural controller 401 (controller 401). Neural network description 402 can include a full specification of neural network 410, including neural architecture 400. For example, neural network description 402 can include a description or specification of architecture of neural network 410 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

Neural network 410 can reflect the architecture 400 defined in neural network description 402. In this non-limiting example, neural network 410 includes an input layer 403, which includes input data, which can be any type of data such as object data from one or more sensors associated with the vehicle. The input data may be raw measurement data pertaining to the location, acceleration, speed, any combination thereof, or the like, of an object in a three-dimensional space (e.g., a pedestrian, a vehicle, a tree, a bicycle, etc.). In one illustrative example, input layer 403 can include data representing a portion of the input data, such as a subset of the object data that includes only location data from the one or more sensors, as described above.

Neural network 410 can include hidden layers 404A through 404N (collectively “404” hereinafter). Hidden layers 404 can include n number of hidden layers, where n is an integer greater than or equal to one. The number of hidden layers can include as many layers as needed for a desired processing outcome and/or rendering intent. Neural network 410 further includes an output layer 406 that provides an output resulting from the processing performed by hidden layers 404 (e.g., where such output may be a bias estimation for each of the one or more sensors). In one illustrative example, output layer 406 can provide an estimated location of the object in the three-dimensional space based on the estimated biases associated with each of the one or more sensors.

Neural network 410, in this example, is a multi-layer neural network of interconnected nodes. Each node can represent a piece of information. Information associated with the nodes is shared among the different layers and each layer retains information as information is processed. In some cases, neural network 410 can include a feed-forward neural network, in which case there are no feedback connections where outputs of the neural network are fed back into itself. In other cases, neural network 410 can include a recurrent neural network, which can have loops that allow information to be carried across nodes while reading in input.

Information can be exchanged between nodes through node-to-node interconnections between the various layers. Nodes of input layer 403 can activate a set of nodes in the first hidden layer 404A. For example, as shown, each input node of input layer 403 is connected to each node of first hidden layer 404A. Nodes of hidden layer 404A can transform the information of each input node by applying activation functions to the information. The information derived from the transformation can then be passed to and can activate the nodes of the next hidden layer (e.g., 404B), which can perform their own designated functions. Example functions include data transformation, pooling, and/or any other suitable functions. In some examples, one of the hidden layers may include a preprocessing layer that transforms input data into a latent representation. In some examples, this may include transforming, calibrating, and/or modifying the data for additional processing by neural network 410. The output of hidden layer (e.g., 404B) can then activate nodes of the next hidden layer (e.g., 404N), and so on. The output of last hidden layer can activate one or more nodes of output layer 406, at which point an output is provided. In some cases, while nodes (e.g., nodes 408A, 408B, 408C) in neural network 410 are shown as having multiple output lines, a node has a single output and all lines shown as being output from a node represent the same output value.

In some cases, each node or interconnection between nodes can have a weight that is a set of parameters derived from training neural network 410. For example, an interconnection between nodes can represent a piece of information learned about the interconnected nodes. The interconnection can have a numeric weight that can be tuned (e.g., based on a training dataset), allowing neural network 410 to be adaptive to inputs and able to learn as more data is processed.

Neural network 410 can be pre-trained to process the features from the data in input layer 403 using different hidden layers 404 in order to provide the output through the output layer 406. In an example in which neural network 410 is used to estimate bias associated with one or more sensors, neural network 410 can be trained using training data that includes example data sets of object data, associated bias, and accuracy metrics. For instance, video data, measurement data, bias data, true zero measurements, detected cuboids in a three-dimensional space, any combination thereof, or the like, can be input into neural network 410, which can be processed by the neural network 410 to generate outputs which can be used to tune one or more aspects of the neural network 410, such as weights, biases, etc. In some examples, neural network 410 may be trained by video input that includes an object, along with sensor data associated with that object (e.g., a cuboid) and object data determined by a post-processing system. The sensor data compared to the object data determines an associated bias for the sensor.

In some cases, neural network 410 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training object data until the weights of the layers are accurately tuned.

Neural network 410 can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for down sampling), and fully connected layers. In other examples, the neural network 410 can represent any other neural or deep learning network, such as an autoencoder, a deep belief nets (DBNs), a recurrent neural network (RNNs), etc.

With the example process of predicting a combined bias associated with one or more measurements and determining, based on the combined bias, an accurate object location in a three-dimensional space described above with reference to FIGS. 1-4, deficiencies and vulnerabilities of existing state estimation (e.g., tracking and object location identification) approaches are addressed whereby autonomous vehicles are able to navigate with an increased awareness of objects due to an increase in accuracy of the state estimation. Further, by dynamically updating bias in real-time based on the training data allows for more accurate bias metrics as opposed to re-training and re-calibrating algorithms for determining object location when a detector and/or the environment changes (e.g., no need to completely re-adjust the bias when the weather changes, the sensor is updated, etc.).

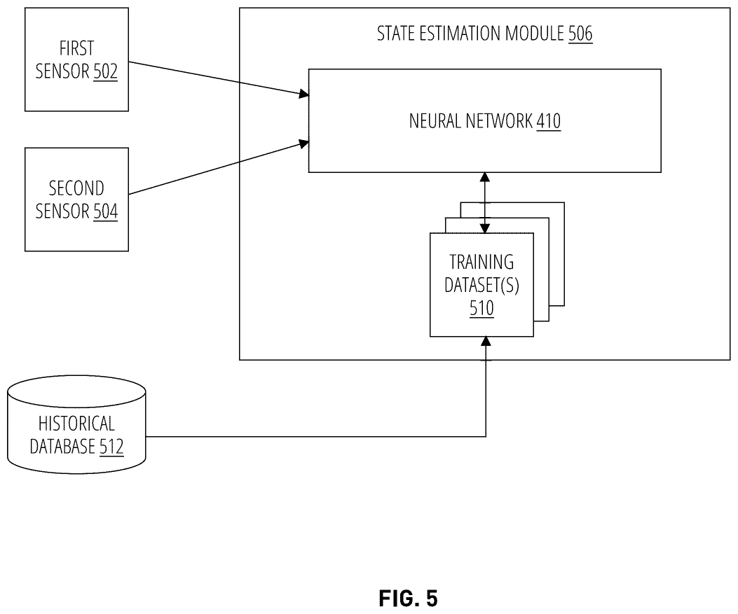

FIG. 5 illustrates a state estimation module according to some aspects of the present disclosure. To begin a detailed description of FIG. 5 showing a state estimation module 506 for generating a prediction for a location of an object in a three-dimensional space. First sensors 502 and second sensor 504 may generate location data associated with an object in the three-dimensional space associated with an autonomous vehicle (e.g., autonomous vehicle 100 as described in FIG. 1 and/or vehicle 304 as described in FIG. 3). The object may be within a range (e.g., detection area 324 as described in FIG. 3) dictated by the first sensor 502, the second sensor 504, an internal computing system associated with the autonomous vehicle (e.g., autonomy computing system 200 as described in FIG. 2 and/or autonomy system 316 as described in FIG. 3). In some examples, first sensor 502 and second sensor 504 may transmit object data associated with the object to neural network 410. The object data may include, but is not limited to, cuboids associated with the object (e.g., center point of the cuboid, size of the cuboid, orientation of the cuboid, etc.), speed of the object, velocity of the object, acceleration of the object, global positioning system (GPS) coordinates of the object, any combination thereof, or the like. First sensor 502 and/or second sensor 504 may be a camera, a Light Detection and Ranging (LiDAR) sensor, a Radio Detection and Ranging (RADAR) sensor, and/or an ultrasound sensor. In some other examples, first sensor 502 and/or second sensor 504 may be a stereo camera, depth camera, 3D object scanner, synthetic aperture radar (SAR) sensor, and/or a multisensor fusion system that includes multiple sensor types to generate one output. First sensor 502 and second sensor 504 may be the same type of sensor (e.g., both cameras, both LiDAR sensors, etc.) or may be different types of sensors (e.g., one camera and one LiDAR, etc.).

Although first sensor 502 and second sensor 504 may transmit object data associated with the same object, the object data may include bias from the first sensor 502 and/or second sensor 504. The bias may impact the overall accuracy of the object data regarding the object. Traditionally, similar systems (e.g., state estimation systems) implement a formulaic approach to parsing through object data from multiple sensors associated with the same object. For example, object data associated with a camera is always treated in a first manner, while object data associated with a LiDAR sensor is always treated in a second manner. This simplistic approach fails to take into consideration the dynamic nature of bias in sensors. Time of day, temperatures, precipitation, wind speeds, type of object, condition of sensor, location of sensor, location of object, and any other variables may impact the bias of a particular sensor. Neural network 410 may be configured by state estimation module 506 to dynamically update the bias associated with first sensor 502 and/or second sensor 504 in real time according to object data. By dynamically updating the bias, neural network 410 may determine an increasingly precise location for the object by either mitigating the impact of an inaccurate sensor (e.g., increasing bias) or increasing the impact of a more accurate sensor (e.g., reducing the bias of a sensor to zero) based on measurements occurring in real time.

The object data may be sent to state estimation module 506 to ultimately output a prediction for the location of the object based on respective bias associated with the data from first sensor 502 and second sensor 504. State estimation module 506 may output the location of the object (e.g., a cuboid associated with a most accurate location for the object based on the object data from first sensor 502 and second sensor 504) and/or a combined bias associated with the location of the object. For example, the combined bias may be a bias associated with the most accurate location for the object, and, in some examples, may be a bias for each of the first sensor 502 and second sensor 504. In some other examples, the combined bias may be a single bias for one of the sensors (e.g., first sensor 502) with the assumption that the bias for second sensor 504 is zero (e.g., second sensor 504 is most accurate). In some other examples, the combined bias may be a bias associated with the location of the object relative to a true zero (e.g., another measurement associated with the autonomous vehicle that is not necessarily associated with first sensor 502 and/or second sensor 504). The output may be determined by the settings configured by an administrator of state estimation module 506. In some examples, additional modules may be included in state estimation module 506 or subsequent to state estimation module 506 to modify the output of neural network 410 and/or state estimation module 506. For example, a subsequent module may receive the bias for each of the first sensor 502 and second sensor 504 and may generate the location of the object.

The object data received from first sensor 502 and/or second sensor 504 may be stored at historical database 512. In some examples, data within the historical database 512 may be transmitted to a post-processing server to generate additional training data. The post-processing server may analyze the object data and may determine a bias associated with the sensor associated with the object data. Using information from the post-processing server, training dataset(s) 510 may be generated to improve the accuracy of neural network 410. In some examples, training dataset(s) 510 may include a sensor type, sensor data (e.g., video data, LiDAR data, radar data, etc.), cuboids detected by the sensors, environmental data (e.g., weather, temperature, condition of the sensor, etc.), bias detected by the post-processing, any combination thereof, or the like. As such, the neural network 410 may be trained by a respective training dataset(s) 510. In some examples, neural network 410 may be updated based on feedback from the post-processing server regarding the accuracy of the prediction for the location of the object.

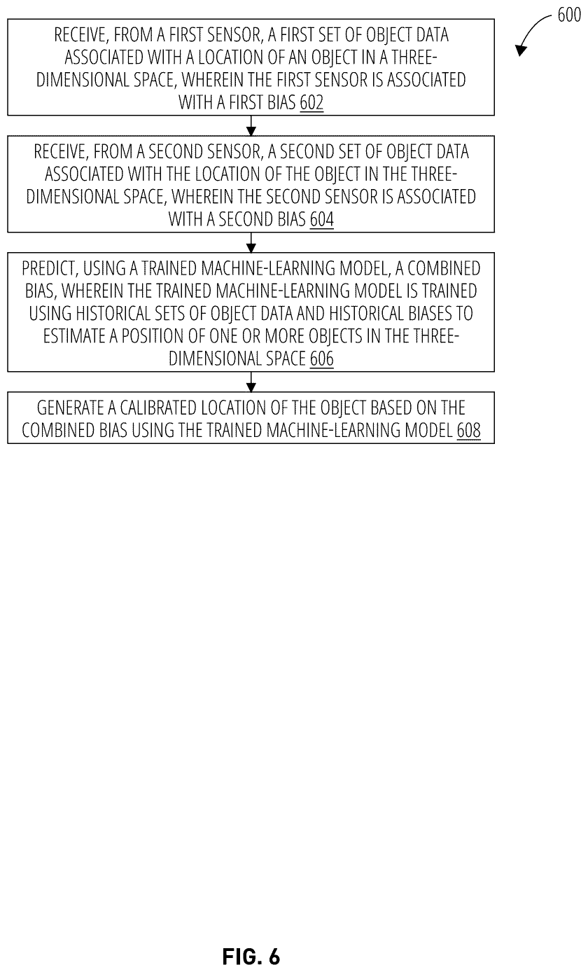

FIG. 6 illustrates a method 600 for state estimation according to some aspects of the present disclosure. Method 600 includes receiving 602, from a first sensor, a first set of object data associated with a location of an object in a three-dimensional space, wherein the first sensor is associated with a first bias. For example, state estimation module 506 (shown in FIG. 5) may receive, from first sensor 502 (shown in FIG. 5), the first set of object data associated with the location of vehicle 306 (shown in FIG. 3) in a three-dimensional space, wherein first sensor 502 is associated with the first bias.

Method 600 includes receiving 604, from a second sensor, a second set of object data associated with the location of the object in the three-dimensional space, wherein the second sensor is associated with a second bias. For example, state estimation module 506 may receive, from second sensor 504 (shown in FIG. 5), the second set of object data associated with the location of vehicle 306 in the three-dimensional space, wherein second sensor 504 is associated with the second bias. In some examples, the first set of object data and the second set of object data include cuboid information, which includes at least a center point, a size, and an orientation angle of a cuboid. In some examples, the first sensor and the second sensor are the same type of sensor. In some other examples, the first sensor and the second sensor may be distinct types of sensors. For example, the first sensor and/or the second sensor may be at least one of a camera, a Light Detection and Ranging (LiDAR) sensor, a Radio Detection and Ranging (RADAR) sensor, or ultrasound sensor.

Method 600 includes predicting 606, using a trained machine-learning model, a combined bias, wherein the trained machine-learning model is trained using historical sets of object data and historical biases to estimate a position of one or more objects in the three-dimensional space. For example, state estimation module 506 may predict, using neural network 410 (shown in FIG. 4 and FIG. 5), the combined bias, wherein neural network 410 is trained using training dataset(s) 510 (shown in FIG. 5) to estimate the position of one or more objects in the three-dimensional space. In some examples, the trained machine-learning model may adjust the first bias and the second bias based on the combined bias. This may include increasing the bias, reducing the bias, setting the bias to zero, any combination thereof, or the like. The bias adjustment may be determined based on a perceived accuracy of the first sensor and/or the second sensor.

Method 600 includes generating 608 a calibrated location of the object based on the combined bias using the trained machine-learning model. For example, state estimation module 506 may generate the calibrated location of vehicle 306 based on the combined bias using neural network 410. In some examples, the calibrated location of the object may be periodically updated according to a predefined time interval. The predefined time interval may be a frequency based on receipt of the first set of object data and the second set of object data, may be defined by an internal computing system of an autonomous vehicle (e.g., autonomy computing system 200 shown in FIG. 2), may be set by an administrator of the network, may be set by a remote server associated with the autonomous vehicle, may be determined by the trained machine-learning model, any combination thereof, or the like.

In some examples, the state estimation module 506 may transmit the calibrated location and/or the combined bias to a remote server and/or computing device for additional processing. The state estimation module 506 may request feedback pertaining to the accuracy of the calibrated location and/or the combined bias. The request may include data regarding the first sensor, the second sensor, the object, environmental elements (e.g., weather, temperature, time of day, etc.), the first and second set of object data, etc. The remote server and/or computing device may process the request and transmit feedback to the state estimation module 506, and the state estimation module 506 may use the feedback to further update, refine, or train the trained machine-learning model.

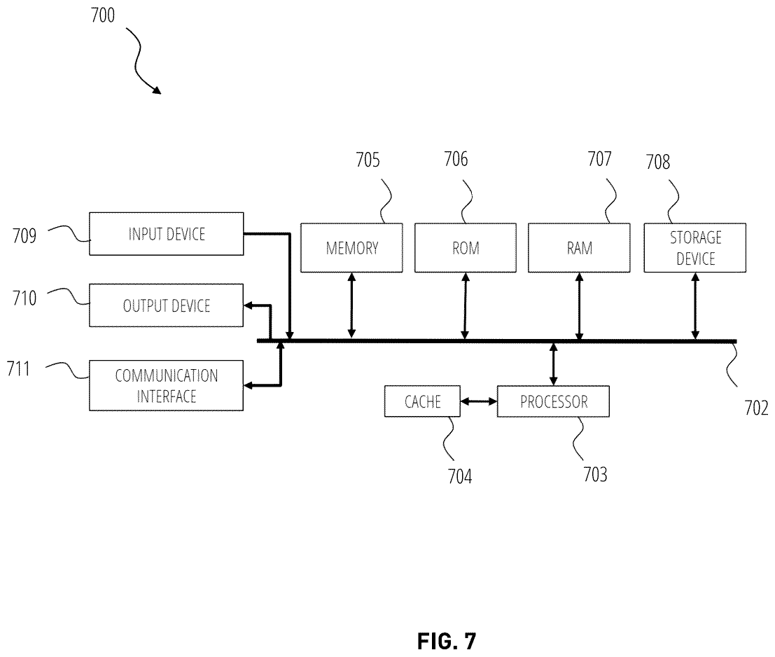

FIG. 7 illustrates an example computing system 700 that can implement various techniques, processes, functions, or methods described herein. The components of computing system 700 are shown in electrical communication with each other using a connection 702, such as a bus. The example computing system 700 includes a processing unit (or processor) 703 and a computing device connection 701 that couples various computing device components, including computing device memory 705, such as a read only memory ROM 706 and a random-access memory RAM 707, to processor 703.

Computing system 700 can include a cache 704 of high-speed memory connected directly with, in close proximity to, or integrated as part of processor 810. Computing system 700 can copy data from memory 705 and/or storage device 708 to cache 704 for quick access by processor 703. In this way, cache 704 can provide a performance boost that avoids processor 703 delays while waiting for data. These and other modules can control or be configured to control processor 703 to perform various actions. Other computing device memory 705 may be available for use as well. Memory 705 can include multiple different types of memory with different performance characteristics. Processor 703 can include any general-purpose processor, central processing unit (CPU), or graphics processing unit (GPU) in combination with a hardware or software provision configured to control processor 703 and stored in storage device 708, as well as any special-purpose processor where software instructions are incorporated into the processor design. Processor 703 may be a self-contained system, containing multiple cores or processors, a bus, memory controller, cache, etc. A multi-core processor may be symmetric or asymmetric.

Storage device 708 is a non-volatile memory and can be one or more of a hard disk or other types of computer readable media that can store data that are accessible by a computer, such as a magnetic cassette, flash memory card, solid state memory device, digital versatile disk, cartridge, RAM 707, ROM 706, or hybrids thereof. Memory 705 or storage device 708 can include software, code, firmware, etc., for controlling processor 703. Other hardware or software modules are contemplated. Memory 705 and storage device 708 are connected to computing device connection 701. In one aspect, a hardware module that performs a particular function can include the software component stored in a computer-readable medium in connection with the necessary hardware components, such as processor 703, computing device connection 701, and so forth, to carry out the function. In the example embodiment, processor 703 may be programmed by encoding an operation or function using one or more executable instructions and providing the executable instructions in memory 705 or storage device 708.

To enable user interaction, computing system 700 includes an input device 709, which can represent any number of input mechanisms, such as a microphone for speech, a touch-sensitive screen for gesture or graphical input, keyboard, mouse, motion input, speech, etc. Computing system 700 can also include output device 710, which can be one or more of a number of output mechanisms known to those of skill in the art. In some instances, multimodal systems can enable a user to provide multiple types of input/output to communicate with computing system 700. Computing system 700 can include communication interface 711, which can generally govern and manage the user input and system output. There is no restriction on operating on any particular hardware arrangement, and therefore the basic features here may easily be substituted for improved hardware or firmware arrangements as they are developed.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) increased accuracy for object detection, thereby increasing safety of autonomous vehicles, (b) higher computational efficiency by processing cuboids as opposed to large point clouds, or (c) dynamic adjustment of sensor bias according to real-time data, thereby increasing the usability of the sensors by accounting for condition of sensors, weather, age of sensors, etc.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

1. A computer-implemented method, comprising:
receiving, from a first sensor, a first set of object data associated with a location of an object in a three-dimensional space, wherein the first sensor is associated with a first bias;
receiving, from a second sensor, a second set of object data associated with the location of the object in the three-dimensional space, wherein the second sensor is associated with a second bias;
predicting, using a trained machine-learning model, a combined bias, wherein the trained machine-learning model is trained using historical sets of object data and historical biases to estimate a position of one or more objects in the three-dimensional space; and
generating a calibrated location of the object based on the combined bias using the trained machine-learning model.

2. The computer-implemented method of claim 1, further comprising:
adjusting the first bias and the second bias based on the combined bias.

3. The computer-implemented method of claim 1, periodically updating the calibrated location according to a predefined time interval.

4. The computer-implemented method of claim 1, further comprising:
querying a computing device for feedback regarding an accuracy of the calibrated location of the object relative to an actual location of the object; and
updating the trained machine-learning model based on the feedback.

5. The computer-implemented method of claim 1, further comprising:
processing the first set of object data and the second set of object data in a preprocessing layer of the trained machine-learning model, wherein the preprocessing layer transforms input data to generate normalized object data.

6. The computer-implemented method of claim 1, wherein at least one of the first set of object data and the second set of object data include cuboid information, which includes at least a center point, a size, and an orientation angle of a cuboid.

7. The computer-implemented method of claim 1, wherein the first sensor is a first type and the second sensor is a second type, wherein the first type is distinct from the second type.

8. The computer-implemented method of claim 1, wherein the first sensor is a first type and the second sensor is a second type, wherein the first type is the same as the second type.

9. The computer-implemented method of claim 1, wherein the first sensor is a first type and the second sensor is a second type, wherein the first type and the second type are each at least one of a camera, a Light Detection and Ranging (LiDAR) sensor, a Radio Detection and Ranging (RADAR) sensor, or ultrasound sensor.

10. A system comprising:
a processor; and
a memory storing instructions that, when executed by the processor, configure the system to:
receive, from a first sensor, a first set of object data associated with a location of an object in a three-dimensional space, wherein the first sensor is associated with a first bias;
receive, from a second sensor, a second set of object data associated with the location of the object in the three-dimensional space, wherein the second sensor is associated with a second bias;
predict, using a trained machine-learning model, a combined bias, wherein the trained machine-learning model is trained using historical sets of object data and historical biases to estimate a position of one or more objects in the three-dimensional space; and
generate a calibrated location of the object based on the combined bias using the trained machine-learning model.

11. The system of claim 10, wherein the instructions further configure the system to:
adjust the first bias and the second bias based on the combined bias.

12. The system of claim 10, wherein the instructions further configure the system to:
periodically update the calibrated location according to a predefined time interval.

13. The system of claim 10, wherein the instructions further configure the system to:
query a computing device for feedback regarding an accuracy of the calibrated location of the object relative to an actual location of the object; and
update the trained machine-learning model based on the feedback.

14. The system of claim 10, wherein the instructions further configure the system to:
process the first set of object data and the second set of object data in a preprocessing layer of the trained machine-learning model, wherein the preprocessing layer transforms input data to generate normalized object data.

15. The system of claim 10, wherein at least one of the first set of object data and the second set of object data include cuboid information, which includes at least a center point, a size, and an orientation angle of a cuboid.

16. The system of claim 10, wherein the first sensor is a first type and the second sensor is a second type, wherein the first type is distinct from the second type.

17. The system of claim 10, wherein the first sensor is a first type and the second sensor is a second type, wherein the first type is the same as the second type.

18. The system of claim 10, wherein the first sensor is a first type and the second sensor is a second type, wherein the first type and the second type are each at least one of a camera, a Light Detection and Ranging (LiDAR) sensor, a Radio Detection and Ranging (RADAR) sensor, or ultrasound sensor.

19. A non-transitory computer-readable storage medium, the computer-readable storage medium including instructions that when executed by a computer, cause the computer to:
receive, from a first sensor, a first set of object data associated with a location of an object in a three-dimensional space, wherein the first sensor is associated with a first bias;
receive, from a second sensor, a second set of object data associated with the location of the object in the three-dimensional space, wherein the second sensor is associated with a second bias;
predict, using a trained machine-learning model, a combined bias, wherein the trained machine-learning model is trained using historical sets of object data and historical biases to estimate a position of one or more objects in the three-dimensional space; and
generate a calibrated location of the object based on the combined bias using the trained machine-learning model.

20. The non-transitory computer-readable storage medium of claim 19, wherein the instructions further configure the computer to:
adjust the first bias and the second bias based on the combined bias.
